(19) United States
(12) Patent Application Publication
(10) Pub. No.: US 2017/0162120 A1
(43) Pub. Date: Jun. 8, 2017

(54) DISPLAY APPARATUS AND CONTROL METHOD THEREOF

(71) Applicant: AU Optronics Corpporation, Hsin-Chu (TW)

(72) Inventors: Sen-Chuan HUNG, Hsin-Chu (TW); Chia-Yuan Yeh, Hsin-Chu (TW)

(21) Appl. No.: 15/371,672

(22) Filed: Dec. 7, 2016

(30) Foreign Application Priority Data
Dec. 8, 2015 (TW) 104141041

(51) Int. Cl. G09G 3/3258

(52) U.S. Cl. CPC G09G 3/3258; G09G 2320/0233; G09G 2310/08; G09G 2300/0819

(57) ABSTRACT

A display has a display panel and a correction circuit. The display panel has a plurality of pixel circuits, and each of the pixel circuits has a plurality of pixels and a shared circuit. Each of the pixels has an organic light-emitting diode (OLED) and a driving transistor for driving the OLED. The shared circuit is coupled to the plurality of pixels and is configured to compensate shifts in threshold voltages of the plurality of pixels according to a received reference voltage. The correction circuit is coupled to the plurality of pixels and is configured to sense a driving current of the pixels of each pixel circuit and to adjust the reference voltage received by the shared circuit of the each pixel circuit according to the detected driving current of the pixels of each pixel circuit.

### TECHNICAL FIELD

The present disclosure relates to a display apparatus and control method thereof, and more particularly to a display apparatus and method thereof capable of compensating shifts in threshold voltages of pixels.

### BACKGROUND ART

FIG. 1 is a schematic diagram of a pixel 100 of a display apparatus of the prior art. The pixel 100 comprises a switch T1A, a driving transistor T1B, a capacitor C1, and an organic light-emitting diode (OLED) 110. The switch T1A has a first end, a second end, and a control end. The first end of the switch T1A is configured to receive a data signal S_{data} and the control end of the switch T1A is configured to receive a scan signal S_{scan}. The driving transistor T1B has a first end, a second end, and a control end. The first end of the driving transistor T1B is configured to receive a predetermined voltage OVDD, the second end of the driving transistor T1B is coupled to a first end of the OLED 110, and the control end of the driving transistor T1B is coupled to the second end of the switch T1A. The capacitor C1 has a first end and a second end. The first end of the capacitor C1 is configured to receive the predetermined voltage OVDD, and the second end of the capacitor C1 is coupled to the control end of the driving transistor T1B.

When the scan signal S_{scan} turns on the switch T1A, a current I_{OLED} of varying magnitude can be conducted by the driving transistor T1B according to the voltage of the data signal S_{data}, resulting in a light emission of the OLED 110. Depending on the characteristics of the transistor, the magnitude of I_{OLED} may be expressed as I_{OLED}=K(V_{SG}−|V_{TH}|)², wherein K is a process parameter of the driving transistor T1B, V_{SG} is a source-gate voltage of the driving transistor T1B, and V_{TH} is a threshold voltage of the driving transistor T1B. The driving transistor T1B in FIG. 1 is a P-type MOSFET, and the source-gate voltage V_{SG} thereof is the predetermined voltage OVDD minus the voltage of the data signal S_{data}.

As such, the pixel 100 can control the magnitude of the current I_{OLED} flowing through the OLED 110 according to the data signal S_{data} of varying magnitude However, as the threshold voltage V_{TH} of the driving transistor T1B may vary due to differences in a process or may be changed after prolonged usage, even if each pixel in the display displays images according to the same data signal S_{data}, the brightness of each pixel may cause non-uniform brightness of frames due to different characteristics of the transistor, and the quality of the image thus deteriorate with time.

Furthermore, since the pixels in the display are distributed in various positions, the predetermined voltage OVDD received by each pixel may also vary due to different levels of line loss, making the problem of non-uniform brightness of frames more difficult to control.

In addition, because the pixel 100 provides no discharging path for the OLED 110, after a previous frame is completed, residual charges may be present in the OLED 110. So if the next frame is a black frame, the problem of insufficient darkness of the frame may occur.

### SUMMARY OF THE DISCLOSURE

One embodiment of the present disclosure provides a display apparatus. The display apparatus comprises a display panel and a correction circuit. The display panel comprises a plurality of pixel circuits, and each of the pixel circuits comprises a plurality of pixels and a shared circuit. Each of the pixels comprises an OLED and a driving transistor for driving the OLED. The shared circuit is coupled to the plurality of pixels for compensating shifts in threshold voltages of the driving transistors of the plurality of pixels according to the received reference voltage. The correction circuit is coupled to the plurality of pixel circuits for detecting a driving current of the plurality of pixels of each pixel circuit and adjusting the reference voltage received by the shared circuit of each pixel circuit according to the detected driving current of the plurality of pixels of each pixel circuit.

In one embodiment of the present disclosure, each OLED in the display apparatus has a first end and a second end, wherein the second end is configured to receive a first predetermined voltage. In addition, each pixel further comprises a first switch, a driving transistor, a capacitor, a driving circuit, a compensation circuit, and a discharging circuit. The first switch has a first end for receiving a data signal, a second end, and a control end for receiving a first control signal. The driving transistor has a first end coupled to the second end of the first switch, a second end coupled to the first end of the OLED, and a control end. The capacitor has a first end and a second end coupled to the control end of the driving transistor. The driving circuit is configured to control electrical connection between the first end of the capacitor and the first end of the driving transistor according to a light emission control signal. The compensation circuit is configured to control electrical connection between the second end of the capacitor and the first end of the OLED according to a second control signal. The discharging circuit is coupled to the first end of the OLED and an initial voltage and controls electrical connection between the first end of the OLED and the initial voltage according to a third control signal. The first shared circuit of each pixel circuit couples the first end of the capacitor to a second predetermined voltage or the reference voltage according to the second control signal and the light emission control signal.

One embodiment of the present disclosure provides a display apparatus. The display apparatus comprises a display panel and a correction circuit. The display panel comprises a plurality of pixel circuits, and each of the pixel circuits comprises a plurality of pixels and a shared circuit. Each of the pixels comprises an OLED, a driving transistor, and a driving circuit. The driving transistor is configured to drive the OLED, and the driving circuit is configured to compensate a shift in a threshold voltage of the driving transistor according to a received reference voltage. The first shared circuit is coupled to the plurality of pixels tor transmitting a second predetermined voltage to the plurality of pixels according to a light emission control signal. The correction circuit is coupled to the plurality of pixel circuits for detecting a driving current of each pixel and adjusting the reference voltage received by the driving circuit according to the driving current.

One embodiment of the present disclosure provides a method for controlling the display apparatus. The method comprises: during a first period of time, setting the voltage of the light emission control signal as a first voltage, setting the voltage of the first control signal as the first voltage, setting the voltage of the second control signal as a second voltage, and setting the voltage of the third control signal as the second voltage; during a second period of time after the first period of time, setting the voltage of the light emission control signal as the first voltage, setting the voltage of the first control signal as the second voltage, setting the voltage of the second control signal as the second voltage, and setting the voltage of the third control signal as the first voltage; and during a third period of time after the second period of time, setting the voltage of the light emission control signal as the second voltage, setting the voltage of the first control signal as the first voltage, setting the voltage of the second control signal as the first voltage, and setting the voltage of the third control signal as the first voltage; and during a fourth period of time after the third period of time, setting the voltage of the light emission control signal as the second voltage, setting the voltage of the first control signal as the first voltage, setting the voltage of the second control signal as the first voltage, and setting the voltage of the third control signal as the second voltage.

### BRIEF DESCRIPTIONS OF THE DRAWINGS

FIG. 1 is a schematic diagram of a pixel of a prior art display apparatus.

FIG. 2 is a function block diagram of a display apparatus according to one embodiment of the present disclosure.

FIG. 3 is a schematic diagram of a pixel in FIG. 2.

FIG. 4 is a schematic diagram of a pixel according to another embodiment of the present disclosure.

FIG. 5 is an operation timing diagram of the pixel in FIG. 3.

FIG. 6 is a schematic diagram of a pixel according to another embodiment of the present disclosure.

FIG. 7 is a schematic diagram of a pixel according to another embodiment of the present disclosure.

FIG. 8 is a schematic diagram of a pixel according to another embodiment of the present disclosure.

FIG. 9 is a function block diagram of a display apparatus according to another embodiment of the present disclosure.

FIG. 10 is a schematic diagram of the display panel in FIG. 9.

FIG. 11 is a schematic diagram of the correction circuit in FIG. 9.

FIG. 12 is a state machine diagram of the state machine in FIG. 11.

FIG. 13 is a schematic diagram of a display panel according to another embodiment of the present disclosure.

FIG. 14 is a schematic diagram of a display panel according to another embodiment of the present disclosure.

FIG. 15 is a schematic diagram of a display panel according to another embodiment of the present disclosure.

FIG. 16 is a graph of a data signal versus a current error of the pixel in FIG. 1.

FIG. 17 is a graph of a data signal versus a current error of the pixel in FIG. 10.

### DETAILED DESCRIPTIONS OF THE DISCLOSURE

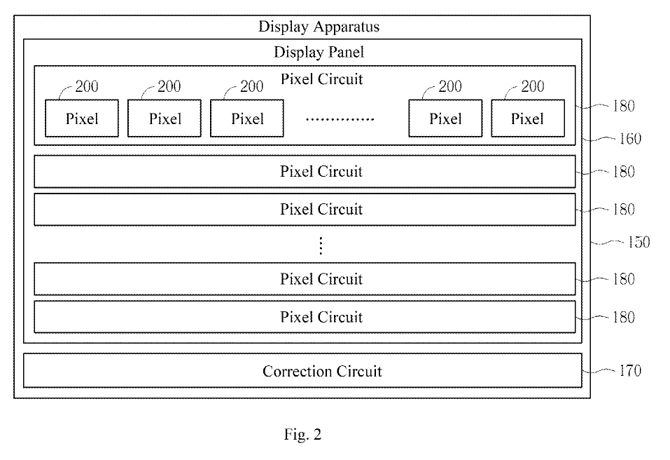

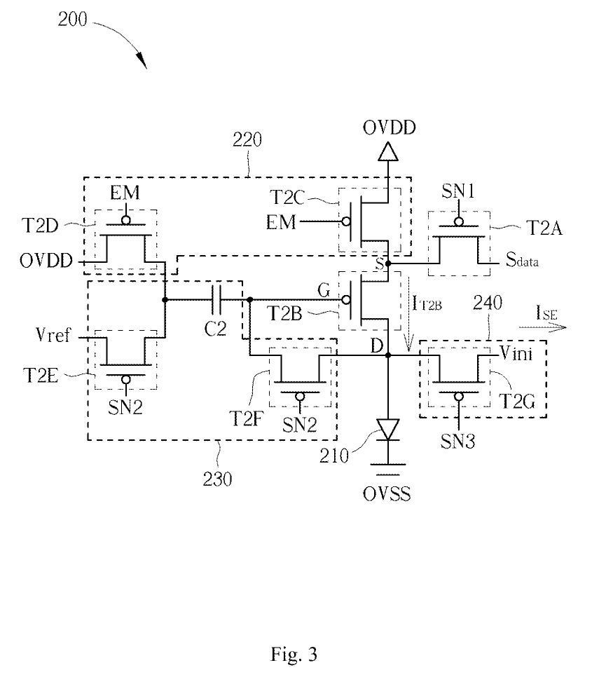

Please refer to FIG. 2 and FIG. 3. FIG. 2 is a function block diagram of a display apparatus 150 according to one embodiment of the present disclosure, and FIG. 3 is a schematic diagram of a pixel 200 according to one embodiment of the present disclosure. The display apparatus 150 comprises a display panel 160 and a correction circuit 170. The display panel 160 comprises a plurality of pixel circuits 180, and each of the pixel circuits 180 comprises a plurality of pixels 200 and a shared circuit. Each of the pixels 200 comprises an OLED 210, a switch T2A, a driving transistor T2B, a driving circuit 220, a compensation circuit 230, and a discharging circuit 240. The OLED 210 has a first end and a second end, and the second end of the OLED 210 may receive a predetermined voltage OVSS. The correction circuit 170 is coupled to the plurality of pixel circuits 180 for detecting a driving current of the plurality of pixels 200 of each pixel circuit 180 and adjusting a reference voltage Vref received by each pixel 200 according to the detected driving current of the plurality of pixels 200 of each pixel circuit 180.

Referring to FIG. 3 again, the switch T2A has a first end, a second end, and a control end. The first end of the switch T2A is configured to receive the data signal S_{data}, and the control end of the switch T2A is configured to receive the first control signal SN1. The driving transistor T2B is configured to drive the OLED 210 and has a first end S, a second end D, and a control end G. The first end S of the driving transistor T2B is coupled to the second end of the switch T2A, and the second end D of the driving transistor T2B is coupled to the first end of the OLED 210.

The driving circuit 220 is coupled to the first end S of the driving transistor T2B for receiving a predetermined voltage OVDD and controlling electrical connection between the predetermined voltage OVDD and the driving transistor T2B according to a light emission control signal EM. The compensation circuit 230 is coupled to the driving circuit 220 and the control end G of the driving transistor T2B for receiving the reference voltage Vref and controlling electrical connection between the control end G of the driving transistor T2B and the second end D of the driving transistor T2B according to a second control signal SN2. The discharging circuit 240 is coupled to the first end of the OLED 210 and an initial voltage Vini for controlling electrical connection between the first end of the OLED 210 and the initial voltage Vini according to a third control signal SN3.

In one embodiment of the present disclosure, the driving circuit 220 comprises a switch T2C and a switch T2D. The switch T2C has a first end, a second end, and a control end. The first end of the switch T2C is configured to receive the predetermined voltage OVDD, the second end of the switch T2C is coupled to the first end S of the driving transistor T2B, and the control end of the switch T2C is configured to receive the light emission control signal EM. The switch T2D has a first end a second end, and a control end. The first end of the switch T2D is configured to receive the predetermined voltage OVDD, the second end of the switch T2D is coupled to the compensation circuit 230, and the control end of the switch T2D is configured to receive the light emission control signal EM.

In one embodiment of the present disclosure, the compensation circuit 230 comprises a capacitor C2, a switch T2E, and a switch T2F. The capacitor C2 has a first end and a second end. The first end of the capacitor C2 is coupled to the second end of the switch T2D, and the second end of the capacitor C2 is coupled to the control end G of the driving transistor T2B. The switch T2E has a first end, a second end, and a control end. The first end of the switch T2E is configured to receive the reference voltage Vref, the second end of the switch T2E is coupled to the first end of the capacitor C2 and the second end of the switch T2D, and the control cud of the switch T2E is configured to receive the second control signal SN2. The switch T2F has a first end, a second end, and a control end. The first end of the switch T2F is coupled to the second end of the capacitor C2, the second end of the switch T2F is coupled to the second end D of the driving transistor T2B, and the control end of the switch T2F is configured to receive the second control signal SN2.

The discharging circuit 240 comprises a switch T2G. The switch T2G has a first end, a second end, and a control end. The first end of the switch T2G is configured to receive the initial voltage Vini, the second end of the switch T2G is coupled to the second end D of the driving transistor T2B, and the control end of the switch T2G is configured to receive the third control signal SN3.

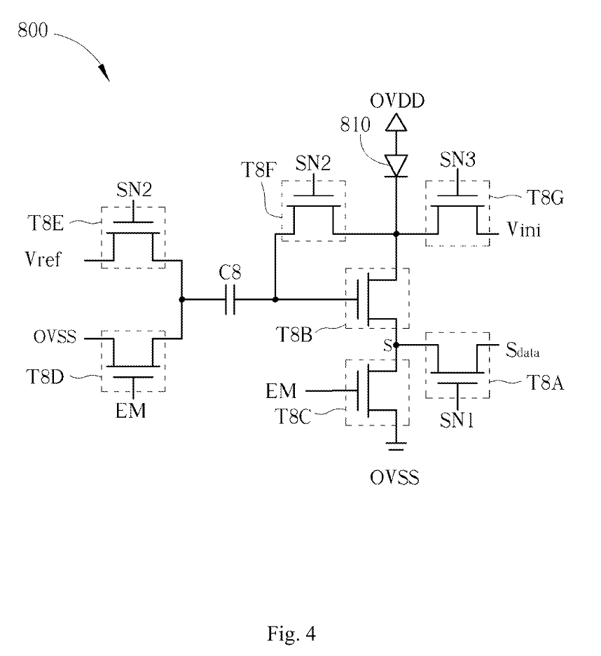

In one embodiment of the present disclosure, the switches T2A to T2G may be a P-type transistor, the predetermined voltage OVSS is less than the predetermined voltage OVDD, and the second end of the OLED 210 is a cathode of the OLED 210. However, the present disclosure is not limited to using P-type transistors as the switches, and in other embodiments of the present disclosure, the switches T2A to T2G may also be an N-type transistor. Please refer to FIG. 4. FIG. 4 is a schematic diagram of a pixel 800 according to one embodiment of the present disclosure. The pixel 800 has an architecture similar to that of the pixel 200, switches T8A to T8G may correspond to the switches T2A to T2G respectively, and a capacitor C8 may correspond to the capacitor C2, except that the switches T8A to T8G in the pixel 800 all are an N-type transistor, a first end of the switch T8C is configured to receive the predetermined voltage OVSS, a first end of the switch T8D is configured to receive the predetermined voltage OVSS, and a second end of an OLED 810 receives the predetermined voltage OVDD. Namely that in the embodiment of FIG. 4, the second end of the OLED 810 is an anode of the OLED 810. The pixel 800 may have the same operation timing as the pixel 200, but control signals of the pixel 800 are reversed with respect to the control signals of the pixel 200.

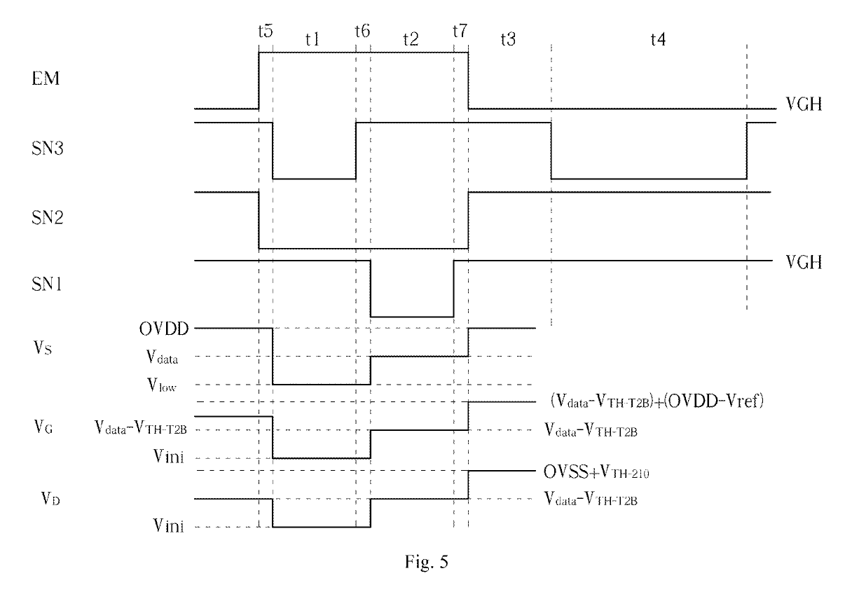

Please refer to FIG. 3 and FIG. 5. FIG. 5 is an operation timing diagram of the pixel 200. For the ease of illustration, the operation timing diagram in FIG. 5 is an exemplary illustration with the switches T2A to T2G being a P-type transistor. Since the first control signal SN1, the light emission control signal EM, the second control signal SN2, and the third control signal SN3 for controlling the switch T2A, the switch T2C, the switch T2D, the switch T2E, the switch T2F, and the switch T2G are all digital signals, the switch T2A, the switch T2C, the switch T2D, the switch T2E, the switch T2F, and the switch T2G may be fully turned on or fully cut off, and thus the variation in the threshold voltages of the switch T2A, the switch T2C, the switch T2D, the switch T2E, the switch T2F, and the switch T2G has smaller influence on the difference of the magnitudes of a current. On the other hand, the driving transistor T2B is controlled by the data signal S_{data} that is an analog signal to turn on a current of varying magnitude. Thus, in one embodiment of the present disclosure, adjustment may be preferentially performed for the influence of the threshold voltage of the driving transistor T2B.

During a period of time t1, the voltage of the light emission control signal EM is a high voltage VGH, the voltage of the first control signal SN1 is the high voltage VGH, the voltage of the second control signal SN2 is a low voltage VGL, and the voltage of the third control signal SN3 is the low voltage VGL. During this time, the switch T2A, the switch T2C, and the switch T2D are cut off. The switch T2G is turned on, so the voltage V_{D} of the second end D of the driving transistor T2B, i.e. the voltage of the first end of the OLED 210, is pulled down to the initial voltage Vini. In one embodiment of the present disclosure, the initial voltage Vini is less than the sum of the predetermined voltage OVSS and a threshold voltage V_{TH-210} of the OLED 210. As such, the switch T2G of the discharging circuit 240 can turn on a path connected to the initial voltage Vini according to the third control signal SN3 to provide a discharging path required for residual charges of the previous operation of the OLED 210 and can ensure that the OLED 210 is effectively turned off. Residual charges of the previous operation of the first end S of the driving transistor T2B may also be discharged via a path provided by the switch T2G, so the voltage V_{S} of the first end S of the driving transistor T2B is also pulled down to a low voltage V_{low} lower than the original one. The switch T2E and the switch T2F also are turned on, so the voltage of the first end of the capacitor C2 is the reference voltage Vref, while the voltage of the second end of the capacitor C2, i.e. the voltage V_{G} of the control end G of the second transistor T2B, is controlled to be at the initial voltage Vini by the switch T2F and the switch T2G.

During a period of time t2, the voltage of the light emission control signal EM is the high voltage VGH, the voltage of the first control signal SN1 is the low voltage VGL, the voltage of the second control signal SN2 is the low voltage VGL, and the voltage of the third control signal SN3 is the high voltage VGH. During this time, the switch T2C, the switch T2D, and the switch T2G are cut off. The switch T2A is turned on, so the voltage V_{S} of the first end S of the driving transistor T2B is the voltage V_{data} of the data signal S_{data}. The switch T2E is turned on, so the voltage of the first end of the capacitor C2 is still maintained at the reference voltage Vref, while the voltage of the second end of the capacitor C2, i.e. the voltage V_{G} of the control end G of the driving transistor T2B, is firstly maintained at a lower voltage. In one embodiment of the present disclosure, the initial voltage Vini during the period of time t1 may be not greater than the voltage level of subtracting an absolute value of the threshold voltage V_{TH-T2B} of the driving transistor T2B from the minimum voltage of the data signal S_{data} (e.g. the voltage of the data signal S_{data} when the image data is white) V_{datamin}, i.e. V_{datamin}−|V_{TH-T2B}|, so the driving transistor T2B is turned on, such that the voltage V_{D} of the second end D of the driving transistor T2B is the voltage V_{data} of the data signal S_{data} minus the absolute value of the threshold voltage V_{TH-T2B} of the driving transistor T2B, i.e. V_{data}−|V_{TH-T2B}|. Since the switch T2F is turned on, the voltage V_{G} of the control end G of the driving transistor T2B is maintained at the same voltage as the second end D of the driving transistor T2B, i.e. V_{data}−|V_{TH-T2B}|.

During a period of time t3, the voltage of the light emission control signal EM is the low voltage VGL, the voltage of the first control signal SN1 is the high voltage VGH, the voltage of the second control, signal SN2 is the high voltage VGH, and the voltage of the third control signal SN3 is the high voltage VGH. During this time, the switch T2A, the switch T2E, the switch T2F, and the switch T2G are all cut off. Since the switch T2D is turned on, the voltage of the first end of the capacitor C2 is changed from the original reference voltage Vref to the predetermined voltage OVDD. Since no discharging path is present around the capacitor C2, the voltage of the second end of the capacitor C2, i.e. the voltage of the control end G of the driving transistor T2B, may be coupled as shown in formula (1):

V_{G}=(V_{data}−|V_{TH-T2B}|)+(OVDD−Vref) (1)

Since the switch T2C is turned on, the voltage V_{S} of the first end S of the driving transistor T2B is pulled up to the predetermined voltage OVDD. Since the turned-on switch T2C and the driving transistor T2B may turn on the OLED 210, the voltage V_{D} of the second end D of the driving transistor T2B is maintained at the sum of the predetermined voltage OVSS and the threshold voltage V_{TH-210} of the OLED 210. At this time, the source-gate voltage V_{SG} of the driving transistor T2B is as shown in formula (2):

V_{SG}=V_{S}−V_{G}=OVDD−[(Vdata−|V_{TH-T2B}|)+(OVDD−Vref)]=Vref−(V_{data}−|V_{TH-T2B}|) (2)

If formula (2) is substituted into the current formula of the transistor, then a current I_{T2B} flowing through the driving transistor T2B is as shown in formula (3):

I_{T2B}=K(V_{SG}−|V_{TH-T2B}|)²=K[Vref−(Vdata−|V_{TH-T2B}|)−|V_{TH-T2B}|]²=K(Vref−Vdata) (3)

wherein K is a process parameter of the driving transistor T2B. Since the reference voltage Vref is of a predetermined fixed value, the current I_{T2B} flowing through the driving transistor T2B may be independent of the threshold voltage V_{TH-T2B} of the driving transistor T2B and the predetermined voltage OVDD. In one embodiment of the present disclosure, in order to ensure that the driving transistor T2B is turned off when the data signal S_{data} has the maximum voltage (e.g. the voltage of the data signal S_{data} when the image data is black) V_{datamax}, the reference voltage Vref may satisfy formula (4):

V_{gate-T2B}≦(V_{datamax}−|V_{TH-T2B}|)+(OVDD−Vref) (4)

wherein the V_{gate-T2B} is a gate cut-off voltage of the driving transistor T2B; namely that when the gate voltage V_{G} of the driving transistor T2B is greater than the gate cut-off voltage V_{gate-T2B} of the driving transistor T2B, the driving transistor T2B is turned off. Formula (5) may be derived according to the conditions of formula (4):

Vref≦(V_{datamax}−|V_{TH-T2B}|)+(OVDD−V_{gate-T2B}) (5)

It can be known from formula (5) that, the reference voltage Vref may be not greater than the sum of the difference between the maximum voltage V_{datamax} of the data signal S_{data} and the absolute value |V_{TH-T2B}| of the threshold voltage of the driving transistor T2B and the difference between the predetermined voltage OVDD and the gate cut-off voltage V_{gate-T2B} of the driving transistor T2B. As such, when the pixel 200 is used to control the pixels in the display, non-uniform brightness of frames due to different characteristics of the transistor of each pixel or due to differences in the predetermined voltage OVDD received by each pixel can be avoided, thereby improving the display quality of frames of the display. In addition, since the discharging circuit 240 can provide a discharging path during the period of time t2, when the display displays a black frame, the problem of insufficient darkness of the frame due to residual charges in the pixels can be avoided.

During a period of time t4, the voltage of the light emission control signal EM is the low voltage VGL, the voltage of the first control signal SN1 is the high voltage VGH, the voltage of the second control signal SN2 is the high voltage VGH, and the voltage of the third control signal SN3 is the low voltage VGL. During this time, the switch T2A and the switch T2F are both cut off. Since the switches T2C, T2B, and T2G are all turned on, a driving current I_{SE} of the pixel 200 may be outputted by the switch T2G. In one embodiment of the present disclosure, the correction circuit 170 in FIG. 2 may detect the driving current I_{SE} of each pixel 200 and adjust the reference voltage Vref received by the switch T2E of the compensation circuit 230 of each pixel 200 according to the detected driving current I_{SE} of each pixel 200.

In one embodiment of the present disclosure, during a period of time t5 before the period of time t1, the voltage of the light emission control signal EM may be the high voltage VGH, the voltage of the first control signal SN1 may be the high voltage VGH, the voltage of the second control signal SN2 may be the low voltage VGL, and the voltage of the third control signal SN3 may be the high voltage VGH. Proceed from the period of time t5 to the period of time t1 when the voltage of the third control signal SN3 is changed from the high voltage VGH into the low voltage VGL.

In one embodiment of the present disclosure, during a period of time t6 between the period of time t1 and the period of time t2, the voltage of the light emission control signal EM may be the high voltage VGH, the voltage of the first control signal SN1 may be the high voltage VGH, the voltage of the second control signal SN2 may be the low voltage VGL, and the voltage of the third control signal SN3 may be the high voltage VGH. Proceed from the period of time t6 to the period of time t2 when the voltage of the first control signal SN1 is changed from the high voltage VGH into the low voltage VGL.

In one embodiment of the present disclosure, during a period of time t7 between the period of time t2 and the period of time t3, the voltage of the light emission control signal EM may be the high voltage VGH, the voltage of the first control signal SN1 may be the high voltage VGH, the voltage of the second control signal SN2 may be the low voltage VGL, and the voltage of the third control signal SN3 may be the high voltage VGH. Proceed from the period of time t7 to the period of time t3 when the voltage of the light emission control signal EM is changed from the high voltage VGH into the low voltage VGL.

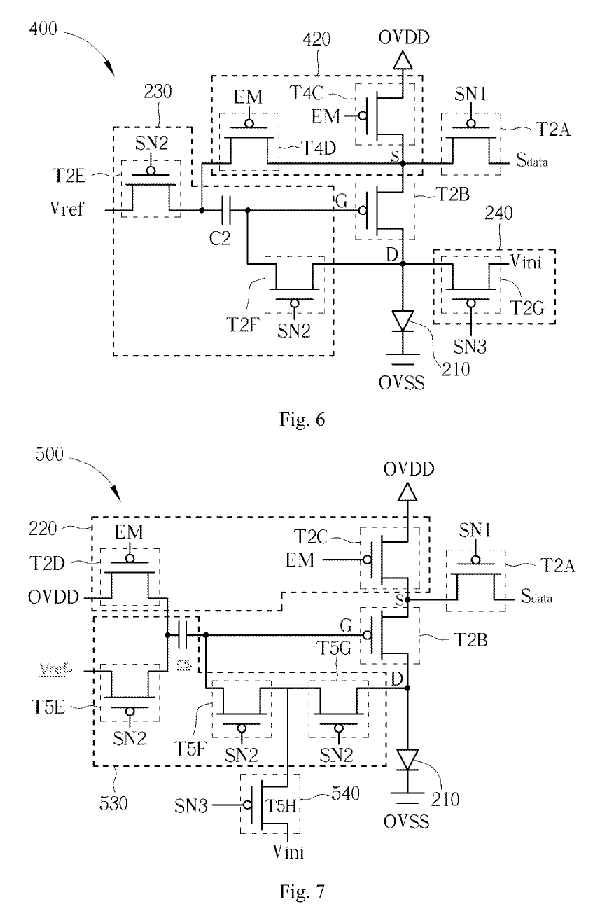

Please refer to FIG. 6. FIG. 6 is a schematic diagram of a pixel 400 according to one embodiment of the present disclosure. The pixel 400 has similar construction and principle of operation to the pixel 200, with a difference in that the driving circuit 420 of the pixel 400 comprises a switch T4C and a switch T4D. The switch T4C has a first end, a second end, and a control end. The first end of the switch T4C is configured to receive the predetermined voltage OVDD, the second end of the switch T4C is coupled to the first end S of the driving transistor T2B, and the control end of the switch T4C is configured to receive the light emission control signal EM. The switch T4D has a first end, a second end, and a control end. The first end of the switch T4D is coupled to the second end of the switch T4C, the second end of the switch T4D is coupled to the first end of the capacitor C2 of the compensation circuit 230, and the control end of the switch T4D is configured to receive the light emission control signal EM.

Since the principle of operation of the pixel 400 is the same as that of the pixel 200, the operation timing diagram of the pixel 400 is also the same as that of FIG. 5. Since during the period of time t1 and the period of time t2, the switch T4C and the switch T4D are both turned off, the operation of the pixel 400 is the same as previously described and is not repeatedly described here. During the period of time t3, the switch T4C and the switch T4D are both turned on and the second end of the switch T4D is pulled up by the switch T4C to the predetermined voltage OVDD, so the voltage of the first end of the capacitor C2 is changed from the original reference voltage Vref into the predetermined voltage OVDD. As such, the voltage V_{G} of the control end G of the driving transistor T2B of the pixel 400 is still (V_{data}−V_{TH-T2B})+(OVDD−Vref) as shown in FIG. 5, and the voltage V_{S} of the first end S of the driving transistor T2B is the predetermined voltage OVDD, so the current I_{T2B} flowing through the driving transistor T2B is still independent of the threshold voltage V_{TH-T2B} of the driving transistor T2B and the predetermined voltage OVDD.

As such, when the pixel 400 is used to control the pixels in the display, non-uniform brightness of frames due to different characteristics of the transistor of each pixel or due to differences in the predetermined voltage OVDD received by each pixel can also be avoided, thereby improving the display quality of frames of the display.

Please refer to FIG. 7. FIG. 7 is a schematic diagram of a pixel 500 according to one embodiment of the present disclosure. The pixel 500 has similar construction and principle of operation to the pixel 200, with the differences in a compensation circuit 530 and a discharging circuit 540 of the pixel 500. The compensation circuit 530 comprises a capacitor C5, a switch T5E, a switch T5F, and a switch T5G. The capacitor C5 has a first end and a second end. The first end of the capacitor C5 is coupled to the second end of the switch T2D, and the second end of the capacitor C5 is coupled to the control end G of the driving transistor T2B. The switch T5E has a first end, a second end, and a control end. The first end of the switch T5E is configured to receive the reference voltage Vref, the second end of the switch T5E is coupled to the first end of the capacitor C5, and the control, end of the switch T5E is configured to receive the second control signal SN2. The switch T5F has a first end, a second end, and a control end. The first end of the switch T5F is coupled to the second end of the capacitor C2, and the control end of the switch T5F is configured to receive the second control signal SN2. The switch T5G has a first end, a second end, and a control end. The first end of the switch T5G is coupled to the second end of the switch T5F, the second end of the switch T5G is coupled to the second end D of the driving transistor T2B, and the control end of the switch T5G is configured to receive the second control signal SN2.

The discharging circuit 540 comprises a switch T5H. The switch T5H has a first end, a second end, and a control end. The first end of the switch T5H is configured to receive the initial voltage Vini, the second end of the switch T5H is coupled to the first, end of the switch T5G, and the control end of the switch T5H is configured to receive the third control signal SN3.

Since the principle of operation of the pixel 500 is the same as that of the pixel 200, the operation timing diagram of the pixel 500 is also the same as that of FIG. 5. During the period of time t1 in FIG. 5, the switch T2A, the switch T2C, and the switch T2D of the pixel 500 are turned off. The switch T5G and the switch T5H are both turned on, so the voltage V_{D} of the second end D of the driving transistor T2B is polled down to the initial voltage Vini. As such, the switch T5H of the discharging circuit 540 can turn on a path connected to the initial voltage Vini according to the third control signal SN3 to provide a discharging path required for residual charges of the previous operation of the OLED 210 and can ensure that the OLED 210 is effectively turned off. Residual charges of the previous operation of the first end S of the driving transistor T2B may also be discharged via a path provided by the switch T5G and the switch T5H, so the voltage V_{S} of the first end S of the driving transistor T2B is also pulled down to the low voltage V_{low}. The switch T5E and the switch T5F also are turned on, so the voltage of the first end of the capacitor C5 is the reference voltage Vref, while the voltage of the second end of the capacitor C5, i.e. the voltage V_{G} of the control end G of the second transistor T2B, is controlled to be at the initial voltage Vini by the switch T5F and the switch T5H.

During the period of time t2, the switch T2C, the switch T2D, and the switch T5H are cut off. The switch T2A is turned on, so the voltage V_{S} of the first end S of the driving transistor T2B is the voltage V_{data} of the data signal S_{data}. The switch T5E is turned on, so the voltage of the first end of the capacitor C5 is still maintained at the reference voltage Vref, the voltage of the second end of the capacitor C5, i.e. the voltage V_{G} of the control end G of the driving transistor T2B, is firstly maintained at a lower voltage such that the driving transistor T2B is turned on, and the voltage V_{D} of the second end D of the driving transistor T2B is the voltage V_{data} of the data signal S_{data} minus the absolute value of the threshold voltage V_{TH-T2B} of the driving transistor T2B, i.e. V_{data}−|V_{TH-T2B}|. Since the switch T5F and the switch T5G are both turned on, the voltage V_{G} of the control end G of the driving transistor T2B is maintained at the same voltage as the second end D of the driving transistor T2B, i.e. V_{data}−|V_{TH-T2B}|.

During the period of time t3, the switch T2A, the switch T5E, the switch T5F, the switch T5G, and the switch T5H are all cut off. The driving transistor T2B, the switch T2C, and the switch T2D are all turned on, so the voltage of the first end of the capacitor C5 is changed from the original reference voltage Vref into the predetermined voltage OVDD. As such, the voltage V_{G} of the control end G of the driving transistor T2B of the pixel 500 is still V_{data}−|V_{TH-T2B}|+(OVDD−Vref) as shown in FIG. 5, and the voltage V_{S} of the first end S of the driving transistor T2B is the predetermined voltage OVDD, so the current I_{T2B} flowing through the driving transistor T2B is still independent of the threshold voltage V_{TH-T2B} of the driving transistor T2B and the predetermined voltage OVDD.

As such, when the pixel 500 is used to control the pixels in the display, non-uniform brightness of frames due to different characteristics of the transistor of each pixel or due to differences in the predetermined voltage OVDD received by each pixel can also be avoided, thereby improving the display quality of frames of the display.

In one embodiment of the present disclosure, the driving circuit 220 of the pixel 500 may also be replaced by the driving circuit 420 of the pixel 400, such that the same effect can still be achieved.

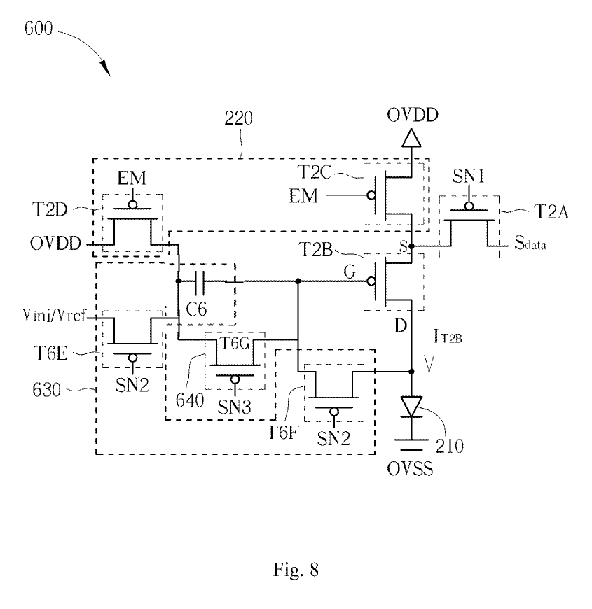

Please refer to FIG. 8. FIG. 8 is a schematic diagram of a pixel 600 according to one embodiment of the present disclosure. The pixel 600 has similar construction and principle of operation to the pixel 200, with the differences in a compensation circuit 630 and a discharging circuit 640 of the pixel 600. Since the principle of operation of the pixel 600 is the same as that of the pixel 200, the operation timing diagram of the pixel 600 is also the same as that of FIG. 5.

The compensation circuit 630 comprises a capacitor C6, a switch T6E, and a switch T6F. The capacitor C6 has a first end and a second end. The first end of the capacitor C6 is coupled to the second end of the switch T2D, and the second end of the capacitor C6 is coupled to the control end G of the driving transistor T2B. The switch T6E has a first end, a second end, and a control end. During the period of time t1 in FIG. 5, the first end of the switch T6E may receive the initial voltage Vini; and during the period of time t2 and the period of time t3, the first end of the switch T6E may receive the reference voltage Vref. The second end of the switch T6E is coupled to the first end of the capacitor C6, and the control end of the switch T6E is configured to receive the second control signal SN2. The switch T6F has a first end, a second end, and a control end. The first end of the switch T6F is coupled to the second end of the capacitor C6, and the control end of the switch T6F is configured to receive the second control signal SN2.

The discharging circuit 640 comprises a switch T6G. The switch T6G has a first end, a second end, and a control end. The first end of the switch T6G is coupled to the second end of the switch T6E, the second end of the switch T6G is coupled to the first end of the switch T6F, and the control end of the switch T6G is configured to receive the third control signal SN3.

During the period of time t1 in FIG. 5, the switch T2A, the switch T2C, and the switch T2D of the pixel 600 are turned off. The switch T6E, the switch T6F, and the switch T6G are ail turned on, and the first end of the switch T6E receives the initial voltage Vini, so the voltage V_{D} of the second end D of the driving transistor T2B is pulled down to the initial voltage Vini. As such, the switch T6G of the discharging circuit 640 can turn on a path connected to the initial voltage Vini according to the third control signal SN3 to provide a discharging path required for residual charges of the previous operation of the OLED 210 and can ensure that the OLED 210 is effectively turned off Residual charges of the previous operation of the first end S of the driving transistor T2B may also be discharged via a path provided by the switch T6E, the switch T6F, and the switch T6G, so the voltage V_{S} of the first end S of the driving transistor T2B is also pulled down to the low voltage V_{low}. The voltages of the first end and the second end of the capacitor C6 are controlled to be at the initial voltage Vini by the switch T6E and the switch T6G, so the voltage V_{G} of the control end G of the second transistor T2B is also controlled to be at the initial voltage Vini.

During the period of time t2, the switch T2C, the switch T2D, and the switch T6G are turned off. The switch T2A is turned on, so the voltage V_{S} of the first end S of the driving transistor T2B is the voltage V_{data} of the data signal S_{data}. The switch T6E is turned on and the first end of the switch T6E receives the reference voltage Vref, so the voltage of the first end of the capacitor C6 is maintained at the reference voltage Vref, the voltage of the second end of the capacitor C6, i.e. the voltage V_{G} of the control end G of the driving transistor T2B, is firstly maintained at a lower voltage such that the driving transistor T2B is turned on, and the voltage V_{D} of the second end D of the driving transistor T2B is the voltage V_{data} of the data signal S_{data} minus the absolute value of the threshold voltage V_{TH-T2B} of the driving transistor T2B, i.e. V_{data}−|V_{TH-T2B}|. Since the switch T6F is turned on, the voltage V_{G} of the control end G of the driving transistor T2B is maintained at the same voltage as the second end D of the driving transistor T2B, i.e. V_{data}−|V_{TH-T2B}|.

During the period of time t3, the switch T2A, the switch T6E, the switch T6F, and the switch T6G are all turned off. The driving transistor T2B, the switch T2C, and the switch T2D are all turned on, so the voltage of the first end of the capacitor C6 is changed from the original reference voltage Vref into the predetermined voltage OVDD. As such, the voltage V_{G} of the control end G of the driving transistor T2B of the pixel 600 is still V_{data}−|V_{TH-T2B}|+(OVDD−Vref) as shown in FIG. 5, and the voltage V_{S} of the first end S of the driving transistor T2B is the predetermined voltage OVDD, so the current I_{T2B} flowing through the driving transistor T2B is still independent of the threshold voltage V_{TH-T2B} of the driving transistor T2B and the predetermined voltage OVDD.

As such, when the pixel 600 is used to control the pixels in the display, non-uniform brightness of frames due to different characteristics of the transistor of each pixel or due to differences in the predetermined voltage OVDD received by each pixel can also be avoided, thereby improving the display quality of frames of the display.

In one embodiment of the present disclosure, the driving circuit 220 of the pixel 600 may also be replaced by the driving circuit 420 of the pixel 400.

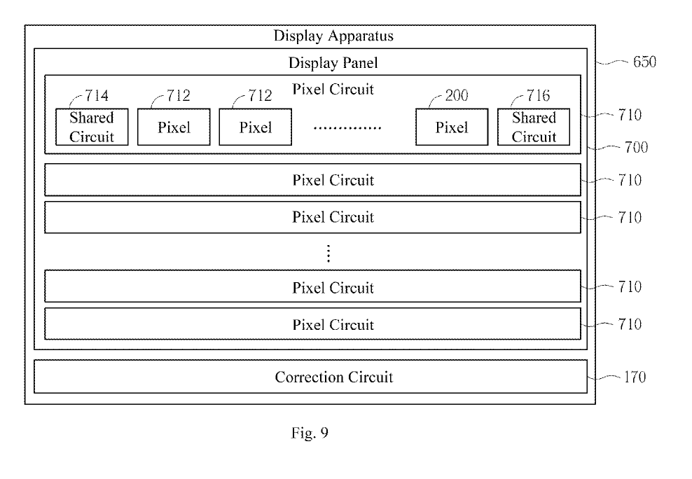

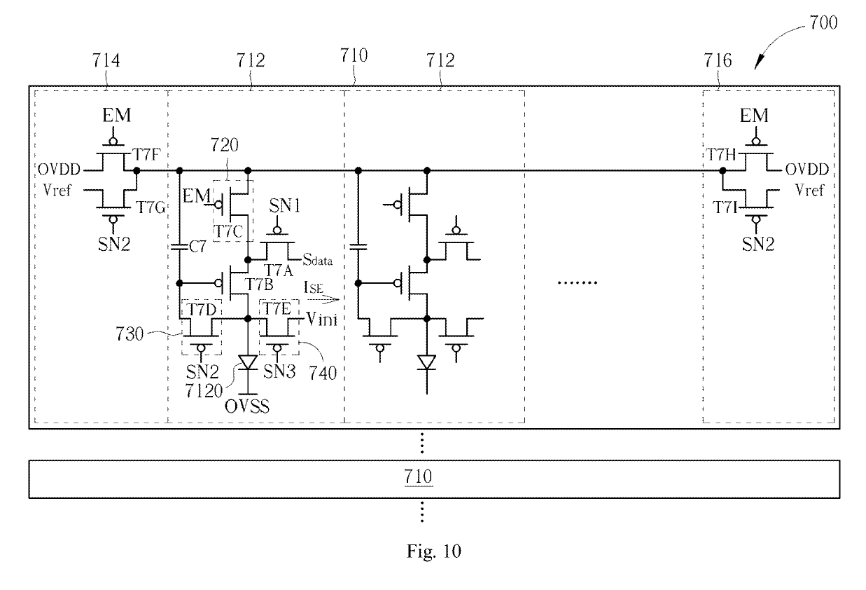

When the pixels are controlled, since the operation of timing of each row of the pixels in a display panel is generally the same, the number of switches maybe saved through a shared circuit, achieving the effect of reducing the area of the display panel. Please refer to FIG. 9 and FIG. 10. FIG. 9 is a function block diagram of a display apparatus 650 according to another embodiment of the present disclosure. FIG. 10 is a schematic diagram of a display panel 700 in FIG. 9. The display apparatus 650 comprises a display panel 700 and a correction circuit 170. The display panel 700 comprises a plurality of pixel circuits 710, and each of the pixel circuits 710 comprises a plurality of pixels 712 and a shared circuit 714. The shared circuit 714 is primarily used to replace the switches T2D and T2E of each pixel 200 of the pixel circuits 180, such that the number of switches of the display apparatus 650 is less than the number of switches of the display apparatus 150 at the same resolution. In addition, since the shared circuit 714 replaces the switches T2D and T2E, the principle of operation of the pixels 712 is the same as that of the pixel 200. Thus, the operation timing diagram of the pixels 712 is also the same as that of FIG. 5.

Each of the pixels 712 comprises an OLED 7120, and one end of the OLED 7120 receives the predetermined voltage OVSS. The shared circuit 714 is coupled to the plurality of pixels 712 in the same pixel circuit 710 for compensating shifts in threshold voltages of the plurality of pixels 712 in the same pixel circuit 710 according to the received reference voltage Vref. The correction circuit 170 is coupled to the plurality of pixel circuits 710 for detecting a driving current of the plurality of pixels 712 of each pixel circuit 710 and adjusting the reference voltage Vref received by the shared circuits 714 of each pixel circuit 710 according to the detected driving current of the plurality of pixels 712 of each pixel circuit 710.

In one embodiment of the present disclosure, each pixel 712 further comprises a switch T7A, a driving transistor 7TB, a capacitor C7, a driving circuit 720, a compensation circuit 730, and a discharging circuit 740. The driving circuit 720, the compensation circuit 730, and the discharging circuit 740 may be a switch T7C, a switch T7D, and a switch T7E, respectively. The switch T7A has a first end, a second end, and a control end. The first end of the switch T7A is configured to receive the data signal S_{data} and the control end of the switch T7A is configured to receive the first control signal SN1. The driving transistor T7B has a first end, a second end, and a control end. The first end of the driving transistor T7B is coupled to the second end of the switch T7A, and the second end of the driving transistor T7B is coupled to the first end of the OLED 7120. The switch T7C has a first end, a second end, and a control end. The second end of the switch T7C is coupled to the first end of the driving transistor T7B, and the control end of the switch T7C is configured to receive the light emission control signal EM. The capacitor C7 has a first end and a second end. The first end of the capacitor C7 is coupled to the first end of the switch T7C, and the second end of the capacitor C7 is coupled to the control end of the driving transistor T7B. The switch T7D has a first end, a second end, and a control end. The first end of the switch T7D is coupled to the second end of the capacitor C7, the second end of the switch T7D is coupled to the second end of the driving transistor T7B, and the control end of the switch T7D is configured to receive the second control signal SN2. The switch T7E has a first end, a second end, and a control end. The first end of the switch T7E is configured to receive the initial voltage Vini, the second end of the switch T7E is coupled to the second end of the driving transistor T7B, and the control end of the switch T7E is configured to receive the third control signal SN3.

The shared circuit 714 comprises switches T7F and T7G. The switch T7F has a first end, a second end, and a control end. The first end of the switch T7F is configured to receive the predetermined voltage OVDD, the second end of the switch T7F is coupled to the first end of the switch T7C, and the control end of the switch T7F is configured to receive the light emission control signal EM. The switch T7G has a first end, a second end, and a control end. The first end of the switch T7G is configured to receive the reference voltage Vref, the second end of the switch T7G is coupled to the first end of the switch T7C, and the control end of the switch T7G is configured to receive the second control signal SN2. The combination of the pixels 712 and the shared circuit 714 can operate according to the same principle as the pixel 200 in FIG. 3, namely that the switch T7A may correspond to the switch T2A, the driving transistor T7B may correspond to the driving transistor T2B, the switch T7C may correspond to the switch T2C, the switch T7D may correspond to the switch T2F, the switch T7E may correspond to the switch T2G, the switch T7F may correspond to the switch T2D, and the switch T7G may correspond to the switch T2E. Although the first end of the switch T2C directly receives the predetermined voltage OVDD while the first end of the T7C receives the predetermined voltage OVDD via the switch T7F, since the switch T7C and the switch T7F are both controlled by the light emission control signal EM, when the switch T7C is turned on, the turned-on switch T7F also causes the switch T7C to receive the predetermined voltage OVDD. Thus, for the pixels 712 and the shared circuit 714, non-uniform brightness of frames due to different characteristics of the transistors of each pixel or due to differences in the predetermined voltage OVDD received by each pixel can also be avoided, thereby improving the display quality of frames of the display. Since the operation timing of each row of the pixels is the same, the same row of the pixels may share the same shared circuit, and as such, the pixels 712 in the display panel 700 only require 5 transistors to be complete, which can further reduce the area needed for the display panel. In particular, when the display has a higher resolution or the display requires more pixels, the display panel 700 can significantly reduce more circuit cost and area.

In one embodiment of the present disclosure, each of the pixel circuits 710 in the display panel 700 may also comprise another shared circuit 716. The shared circuit 716 has similar construction and principle of operation to the shared circuit 714. The shared circuit 716 comprises switches T7H and T7I. The switch T7H has a first end, a second end, and a control end. The first end of the switch T7H is configured to receive the predetermined voltage OVDD, the second end of the switch T7H is coupled to the first end of the switch T7C, and the control end of the switch T7H is configured to receive the light emission control signal EM the second control signal SN2. The switch T7I has a first end, a second end, and a control end. The first end of the switch T7I is configured to receive the reference voltage Vref, the second end of the switch T7I is coupled to the first end of the switch T7C, and the control end of the switch T7I is configured to receive the second control signal SN2. The shared circuits 714 and 716 may be disposed in non-display regions of the display panel at two different sides of the pixel array. As such, the problem of differences in the predetermined voltage OVDD and the reference voltage Vref received by the pixels 712 at two sides of the display panel due to the line impedance can be avoided, and the circuit area required in a display region of the display panel can also be reduced.

In one embodiment of the present disclosure, the switches T7A to T7G may be a P-type transistor, the predetermined voltage OVSS is less than the predetermined voltage OVDD, and the second end of the OLED 7120 is a cathode of the OLED 7120. However, the present disclosure is not limited to the P-type transistor as the switches, and in other embodiments of the present disclosure, the switches T7A to T7G may also be an N-type transistor.

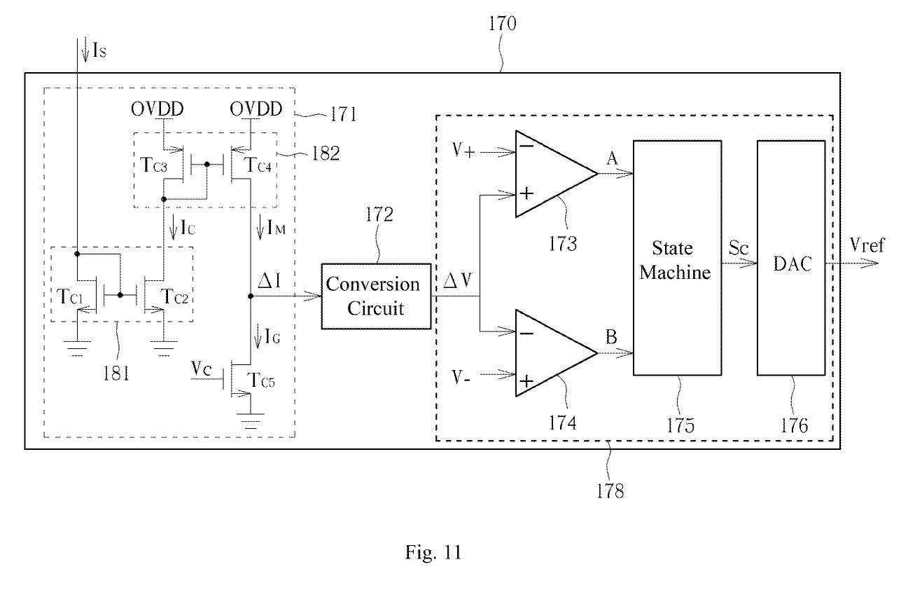

Please refer to FIG. 11. FIG. 11 is a schematic diagram of the correction circuit 170 in FIG. 9. The correction circuit 170 comprises a current mirror circuit 171, a conversion circuit 172, and a comparison circuit 178. The current mirror circuit 171 is configured to mirror the detected driving current I_{S} of the plurality of pixels 712 of each pixel circuit 710 to output a mirrored current I_{M}. The driving current I_{S} is the sum of the driving currents I_{SE} outputted by the pixels 712 of the same pixel circuit 710 during the period of time t4. In one embodiment of the present disclosure, the current mirror circuit 171 includes a first current mirror 181 and a second current mirror 182. The first current mirror 181 comprises transistors T_{C1} and T_{C2} for mirroring the driving current I_{S} to generate a current I_{C}. Similarly, the second current mirror 182 comprises transistors T_{C3} and T_{C4} for mirroring the current I_{C} to generate the mirrored current I_{M}. If the ratio of the width length ratio (W/L) of the transistor T_{C2} to the W/L of the T_{C1} is M and the ratio of the W/L of the T_{C4} to the W/L of the T_{C3} is N, then I_{M}=I_{C}×N=I_{S}×N×M, wherein M and N are both positive numbers. It is to be understood that although the current mirror circuit 171 comprises two current mirrors in the present embodiment, the present disclosure is not limited thereto. In other words, in other embodiments of the present disclosure, the current mirror circuit 171 may only comprise a single current mirror, three current mirrors, or more current mirrors, and the number of current mirrors of the current mirror circuit 171 may be adjusted according to the design requirements of different circuits.

In addition, the current mirror circuit 171 may further comprise a transistor T_{C5}, a gate of which receives a control voltage V_{C}. The correction circuit 170 may control the level of conductivity of the transistor T_{C5} by controlling the magnitude of the control voltage V_{C}, thereby controlling the magnitude of a current I_{G} flowing through the transistor T_{C5}. In FIG. 11, ΔI indicates a variation of the mirrored current I_{M}. Because I_{M}=I_{G}+ΔI, ΔI=I_{M}−I_{G}. Since the magnitude of the current I_{G} may be controlled by controlling the voltage V_{C}, the current I_{G} may be used as a reference current for the correction circuit 170 when adjusting the reference voltage Vref of the pixel 200.

The conversion circuit 172 detects the variation ΔI of the mirrored current I_{M} and convert the variation ΔI of the mirrored current I_{M} into a voltage variation ΔV. In one embodiment of the present disclosure, the conversion circuit 172 maybe a capacitive transimpedance amplifier (CTIP). The comparison circuit 178 is configured to compare the voltage variation ΔV, a first predetermined comparison potential V+, and a second predetermined comparison potential V−, and adjust the reference voltage Vref during the period of time t4 according to the results of comparison. The first predetermined comparison potential V+ is higher than the second predetermined comparison potential V−.

In one embodiment of the present disclosure, the comparison circuit 178 comprises a first comparator 173, a second comparator 174, and a state machine 175. The first comparator 173 is coupled to the conversion circuit 172 for comparing the voltage variation ΔV and the first predetermined comparison potential V+ to output a comparison signal A. The second comparator 174 is coupled to the conversion circuit 172 for comparing the voltage variation ΔV and the second predetermined comparison potential V− to output a comparison signal B. The state machine 175 is coupled to the first comparator 173 and the second comparator 174 for outputting a state control signal S_{C} according to the comparison signals A and B to adjust the reference voltage Vref. The comparison signals A and B are one-bit digital signals, and when the voltage variation ΔV is greater than the first predetermined comparison potential V+, the value of the comparison signal A is “1”; in contrast, when the voltage variation ΔV is less than the first predetermined comparison potential V+, the value of the comparison signal A is “0”. Similarly, when the voltage variation ΔV is less than the second predetermined comparison potential V−, the value of the comparison signal B is “1”; in contrast, when the voltage variation ΔV is greater than the second predetermined comparison potential V−, the value of the comparison signal B is “0”. Thus, when the values of the comparison signals A and B are both “0”, it is indicated that the voltage variation ΔV is between the first predetermined comparison potential V+ and the second predetermined comparison potential V−, and that the reference voltage Vref has been corrected to a suitable range. When the value of the comparison signal A is “1” and the value of the comparison signal B is “0”, it is indicated that the voltage variation ΔV is greater than the first predetermined comparison potential V+, and that the reference voltage Vref is too high and thus needs to be lowered. When the value of the comparison signal A is “0” and the value of the comparison signal B is “1”, it is indicated that the voltage variation ΔV is less than the second predetermined comparison potential V−, and that the reference voltage Vref is too low and thus needs to be raised. When the values of the comparison signals A and B are both “1”, it indicates that the comparison circuit 178 has malfunctioned and has to initialize the comparison circuit 178 again because it is impossible for the voltage variation ΔV to be both greater than the first predetermined comparison potential V+ and less than the second predetermined comparison potential V−. The comparison circuit 178 may further comprise a digital to analog converter (DAC) 176 for converting the state control signal S_{C} into the reference voltage Vref.

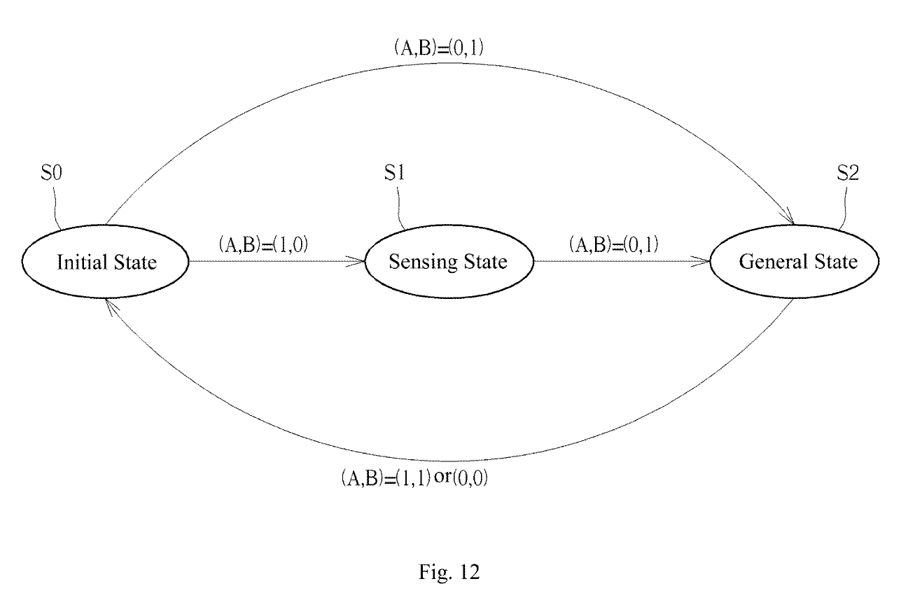

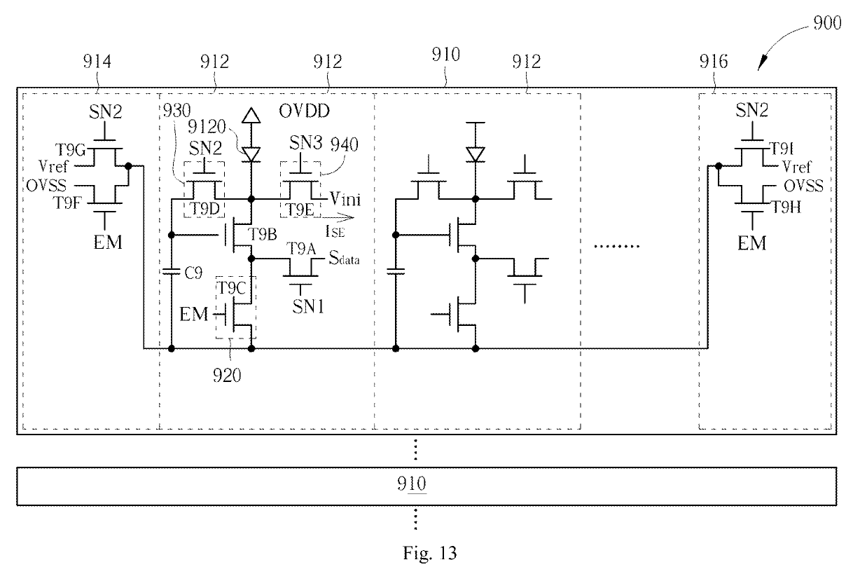

Please refer to FIG. 12. FIG. 12 is a state machine diagram of the state machine 170 in FIG. 11. Initially, the state machine 170 is in an initialized state S0, and may be switched to a sensing state S1 or a general state S2 according to the different values of the comparison signals A and B. For example, during the period of time t4, the state machine 175 is in the sensing state S1 to adjust the reference voltage Vref according to the driving current I_{S}.

It is to be noted that in one embodiment of the present disclosure, the plurality of pixel circuits 710 of the display apparatus 650 are sequentially driven, so the magnitude of the reference voltage Vref received by the shared circuit 714 of each pixel circuit 710 may not be identical, and the correction circuit 170 sequentially adjusts the voltage value of the reference voltage Vref received by each pixel circuit 710.

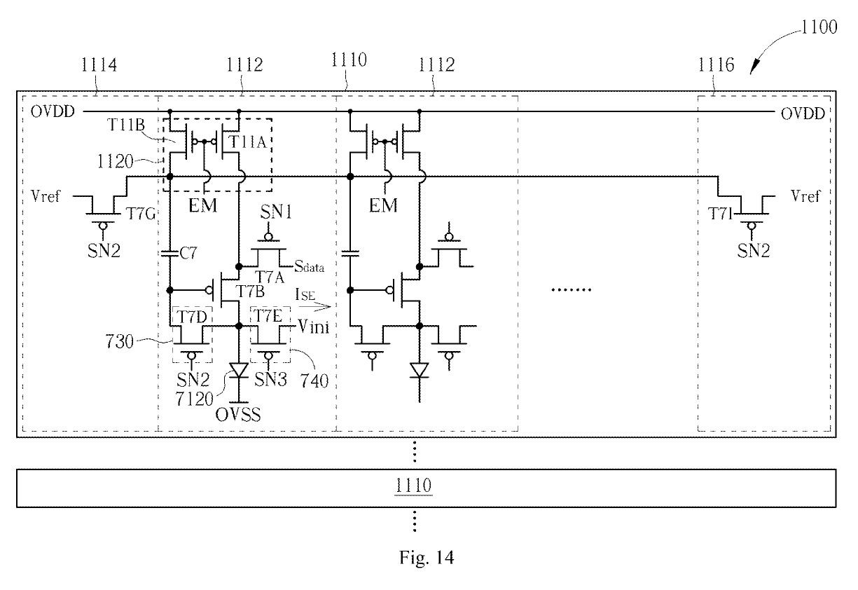

Please refer to FIG. 13. FIG. 13 is a schematic diagram of a display panel 900 according to one embodiment of the present disclosure. The display panel 900 has an architecture similar to the display panel 700. The display panel 900 comprises at least one pixel circuit 910, and each of the pixel circuits 910 comprises a plurality of pixels 912 and shared circuits 914 and 916. In one embodiment of the present disclosure, each of the pixels 912 comprises a switch T9A, an OLED 9120, a capacitor C9, a driving transistor T9B, a driving circuit 920, a compensation circuit 930, and a discharging circuit 940. The driving circuit 920, the compensation circuit 930, and the discharging circuit 940 may be a switch T9C, a switch T9D, and a switch T9E, respectively. The shared circuit 914 comprises switches T9F and T9G, and the shared circuit 916 comprises switches T9H and T9I. The driving transistor T9B may correspond to the driving transistor T7B, and the switches T9A and T9C to T9I may correspond to the switches T7A and T7C to T7I, respectively, except that the switches T9A to T9I in the pixel 900 are all an N-type transistor. And since the operation manner of the N-type transistor is the opposite of that of the P-type transistor, first ends of the switches T9F and T9H are configured to receive the predetermined voltage OVSS, and a second end of the OLED 9120 is configured to receive the predetermined voltage OVDD, namely that in the embodiment of FIG. 13, the second end of the OLED 9120 is an anode of the OLED 9120.

Please refer to FIG. 14. FIG. 14 is a schematic diagram of a display panel 1100 according to one embodiment of the present disclosure. The display panel 1100 has an architecture similar to the display panel 700. The display panel 1100 comprises at least one pixel circuit 1110, and each of the pixel circuits 1110 comprises a plurality of pixels 1112 and shared circuits 1114 and 1116. The shared circuit 1114 is similar to the shared circuit 714, and the difference between the shared circuit 1114 and the shared circuit 714 is that the shared circuit 1114 only has the switch T7G and not the switch T7F. The shared circuit 1116 is similar to the shared circuit 716, and the difference between the shared circuit 1116 and the shared circuit 716 is that the shared circuit 1116 only has the switch T7I and not the switch T7H. In addition, the pixels 1112 are similar to the pixels 712, and the difference between the pixels 1112 and the pixels 712 is that the driving circuit 720 of the pixels 712 is replaced with a driving circuit 1120. According to another embodiment of the present disclosure, one of the shared circuit 1114 and the shared circuit 1116 may be omitted, such that a shared circuit is only located at one side of the display panel.

The driving circuit 1120 is configured to control whether the first end of the capacitor C7 and the first end of the driving transistor T7B receive a predetermined voltage OVDD according to the light emission control signal EM. The driving circuit 1120 of each pixel circuit 1110 has two switches, T11A and T11B. Control ends of the switches T11A and T11B are configured to receive the light emission control signal EM, first ends of the switches T11A and T11B are configured to receive the predetermined voltage OVDD a second end of the switch T11A is coupled to the second end of the switch T7A, and a second end of the switch T11B is coupled to the first end of the capacitor C7. In the present embodiment, the operation timing diagram of the pixels 1112 is also the same as that of FIG. 5. Since the operation of the switches T7C, T7F, and T7H of the display panel 700 is controlled by the light emission control signal EM, and the operation of the switches T11A and T11B of the display panel 1100 is also controlled by the light emission control signal EM, the timing for the potential of the first end of the first capacitor C7 of the display panel 1100 and the potential of the second end of the switch T7A is the same as the timing for the potential of the first end of the first capacitor C7 of the display panel 700 and the potential of the second end of the switch T7A. Thus, the operation manner of the switch T7A of the pixels 1112, the compensation circuit 730, and the discharging circuit 740 is the same as the operation manner of the switch T7A of the pixels 712, the compensation circuit 730, and the discharging circuit 740, and is not repeatedly described here.

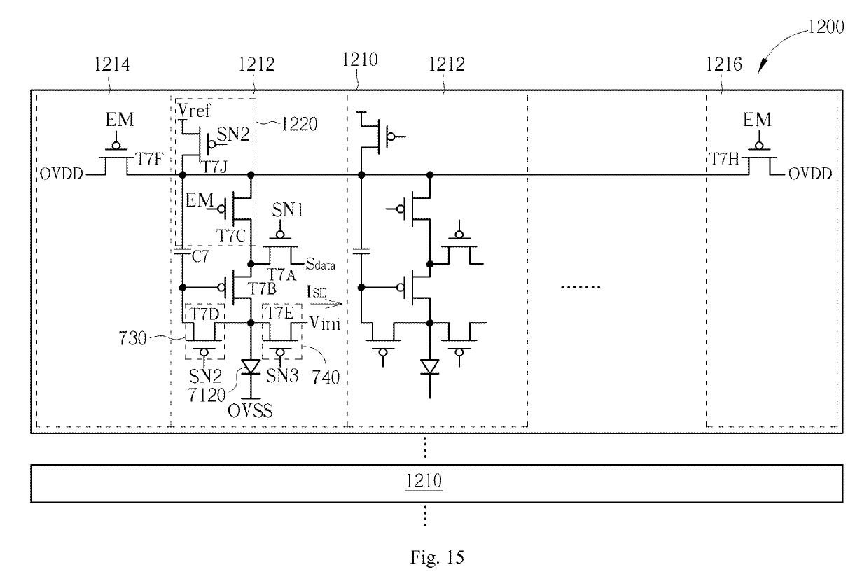

Please refer to FIG. 15. FIG. 15 is a schematic diagram of a display panel 1200 according to one embodiment of the present disclosure. The display panel 1200 has an architecture similar to the display panel 700. The display panel 1200 comprises at least one pixel circuit 1210, and each of the pixel circuits 1210 comprises a plurality of pixels 1212 and shared circuits 1214 and 1216. The shared circuit 1214 is similar to the shared circuit 714, and a difference between the shared circuit 1214 and the shared circuit 714 is that the shared circuit 1214 only has the switch T7F and not the switch T7G. The shared circuit 1216 is similar to the shared circuit 716, and a difference between the shared circuit 1216 and the shared circuit 716 is that the shared circuit 1116 only has the switch T7H and not the switch T7I. According to another embodiment of the present disclosure, one of the shared circuit 1214 and the shared circuit 1216 may be omitted, such that a shared circuit is only located at one side of the display panel.

Each of the pixels 1212 comprises an OLED 7120, a driving transistor T7B, and a driving circuit 1220. The driving transistor T7B is configured to drive the OLED 7120, and the driving circuit 1220 is configured to compensate a shift in a threshold voltage of the driving transistor T7B according to the received reference voltage Vref. The shared circuits 1214 and 1216 are coupled to the plurality of pixels 1212 for transmitting the second predetermined voltage OVDD to the pixels 1212 according to the light emission control signal EM. In the present embodiment, the display panel 1200 also comprises a correction circuit. The correction circuit is coupled to the plurality of pixel circuits 1210 for detecting the driving current I_{SE} of each pixel 1212 and adjusting the reference voltage Vref received by the driving circuit 1220 of each pixel 1212 according to the driving current I_{SE}.

In the present embodiment, the driving circuit 1220 is configured to control electrical connection between the first end of the capacitor C7 and the first end of the driving transistor T7B according to the light emission control signal EM, and to control whether the first end of the capacitor C7 receives the reference voltage Vref according to the second control signal SN2. The pixels 1212 are similar to the pixels 712, and the difference between the pixels 1212 and the pixels 712 is that the driving circuit 1220 of the pixels 1212 further comprises a switch T7J in addition to the switch T7C of the driving circuit 720. The switch T7J has a first end, a second end, and a control end. The first end of the switch T7J receives the reference voltage Vref, the second end of the switch T7J is coupled to the first end of the capacitor C7, and the control end of the switch T7J is configured to receive the second control signal SN2. In the present embodiment, the operation timing diagram of the pixels 1212 is also the same as that of FIG. 5. Since the operation of the switches T7G and T7I of the display panel 700 is controlled by the second control signal SN2, and the operation of the switch T7J of the display panel 1200 is also controlled by the second control signal SN2, the timing for the potential of the first end of the first capacitor C7 of the display panel 1200 is the same as the timing for the potential of the first end of the first capacitor C7 of the display panel 700. Thus, the operation manner of the switch T7A of the pixels 1212, the compensation circuit 730, and the discharging circuit 740 is the same as the operation manner of the switch T7A of the pixels 712, the compensation circuit 730, and the discharging circuit 740, and is not repeatedly described here.

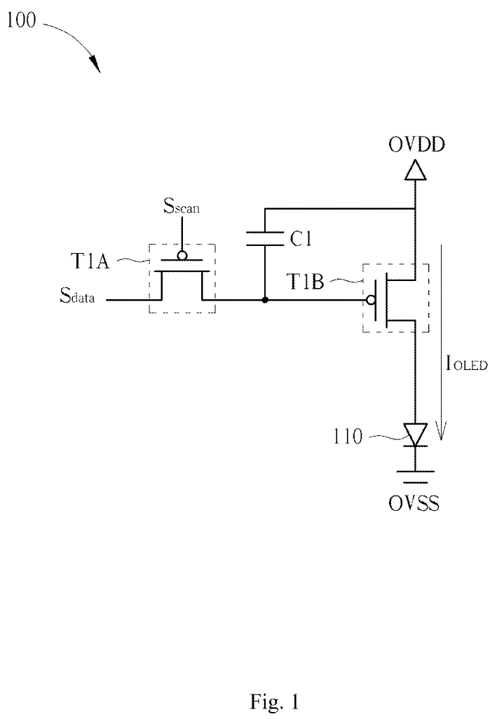

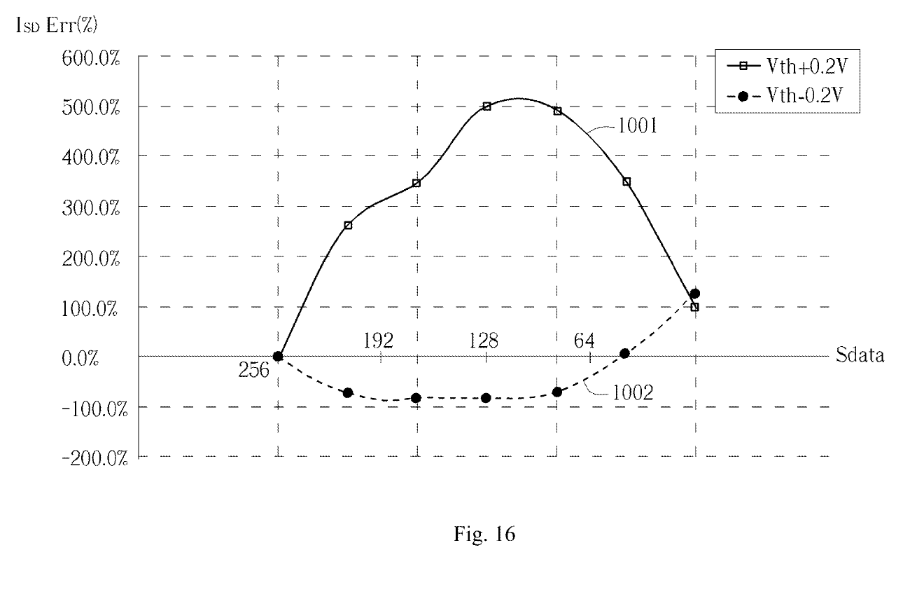

Please refer to FIG. 16. FIG. 16 is a graph of a data signal versus a current error of the pixel 100 in FIG. 1. In FIG. 16, the horizontal axis representing the data signal S_{data} is expressed as a grayscale value, and the vertical axis represents the percent current error I_{SD}Err (%). A curve 1001 indicates the current errors I_{SD}Err generated when the driving transistor T1B receives different data signals S_{data}, where the threshold voltage V_{TH-T1B} of the driving transistor T1B of the pixel 100 is increased by 0.2 V due to variation; A curve 1002 indicates the current errors I_{SD}Err generated when the driving transistor T1B receives different data signals S_{data}, where the threshold voltage V_{TH-T1B} of the driving transistor T1B of the pixel 100 is decreased by 0.2 V due to variation.

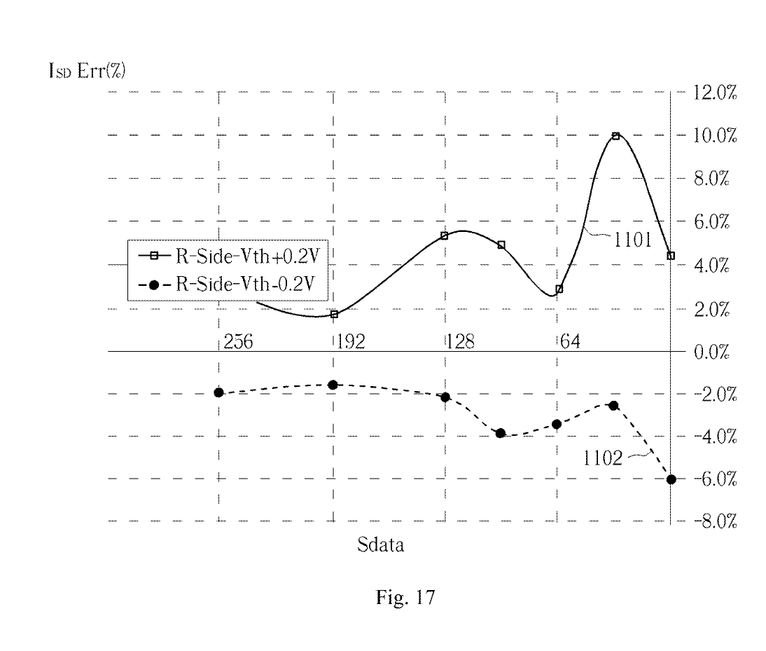

Please refer to FIG. 17. FIG. 17 is a graph of a data signal versus a current error of the pixel 712 in FIG. 10. In FIG. 17, the horizontal axis representing the data signal S_{data} is expressed as a grayscale value, and the vertical axis represents the percent current error I_{SD}Err (%). A curve 1101 indicates the current errors I_{SD}Err generated when the driving transistor T7B receives different data signals S_{data}, where the threshold voltage V_{TH-T1B} of the driving transistor T7B of the pixel 712 is increased by 0.2 V due to variation; A curve 1102 indicates the current errors I_{SD}Err generated when the driving transistor T7B receives different data signals S_{data}, where the threshold voltage V_{TH-T1B} of the driving transistor T7B of the pixel 712 is decreased by 0.2 V due to variation.

It can be found by comparing of FIG. 16 and FIG. 17 that, when the grayscale value of the data signal S_{data} is the same, the current errors resulted from the pixels 712 being subjected to variations of the threshold voltage V_{TH-T2B} of the driving transistor T2B are much less than the current errors resulted from the pixel 100 being subjected to variations of the threshold voltage V_{TH-T2B} of the driving transistor T1B. Take the grayscale value of 64 as an example, when the threshold voltages of the driving transistors T1B and T7B are equally increased by 0.2 V due to variation, the current error of the pixel 100 is more than 400% while the current error of the pixels 712 is only about 5%. In addition, the maximum current error of the pixel 100 may be even up to 500%, while the current errors of the pixels 712 can be controlled to be less 10%. Thus, through the pixels and the display panel in the embodiments of the present disclosure, the problem of non-uniform brightness of frames due to different characteristics of transistors of the pixels can be greatly reduced, and thus the yield of the display can be effectively increased and the display quality of frames of the display can be improved.

In sum, the pixels and the display panel provided in the embodiments of the present disclosure can avoid non-uniform brightness of frames due to different characteristics of the transistor of each pixel or due to differences in the predetermined voltage received by each pixel, thereby improving the display quality of frames of the display. In addition, since the discharging circuit of the pixels in the embodiments of the present disclosure can provide a discharging path, when the display displays a black frame, the problem of insufficient darkness of the frame due to residual charges in the pixels can be avoided. Further, the pixels provided in the embodiments of the present disclosure can constitute the display panel with shared circuit to achieve the effect of area reduction.

The above description only provides preferred embodiments of the present disclosure, and all equivalent changes and modifications made according to the claims of the present disclosure falls within the scope of the present disclosure.

1. A display apparatus, comprising:
a display panel comprising a plurality of pixel circuits, each of the pixel circuits comprising:
a plurality of pixels, wherein each of the pixels comprises an organic light-emitting diode (OLED) and a driving transistor for driving the OLED; and
a first shared circuit, coupled to the pixels, for compensating a shift in a threshold voltage of the driving transistor of each pixel of each pixel circuit according to a reference voltage; and
a correction circuit, coupled to the pixel circuits, for detecting a driving current of pixels of each pixel circuit and adjusting the reference voltage received by the first shared circuit of each pixel circuit according to the detected driving current of the pixels of the each pixel circuit.

2. A display apparatus of claim 1, wherein the correction circuit sequentially adjusts a voltage value of the reference voltage received by the first shared circuit of the each pixel circuit.

3. The display apparatus of claim 1, wherein the correction circuit comprises:
a current mirror circuit for mirroring the detected driving current of the pixels of each pixel circuit to output a mirrored current;
a conversion circuit for converting a variation of the mirrored current into a voltage variation; and
a comparison circuit for comparing the voltage variation, a first predetermined comparison potential, and a second predetermined comparison potential, and adjusting the reference voltage according to comparison results, wherein the first predetermined comparison potential is not equal to the second predetermined comparison potential.

4. The display apparatus of claim 3, wherein the comparison circuit comprises:
a first comparator, coupled to the conversion circuit, for comparing the voltage variation and the first predetermined comparison potential to output a first comparison signal;
a second comparator, coupled to the conversion circuit, for comparing the voltage variation and the second predetermined comparison potential to output a second comparison signal; and
a state machine, coupled to the first comparator and the second comparator, for adjusting the reference voltage according to the first comparison signal and the second comparison signal.

5. The display apparatus of claim 1, wherein the OLED has a first end and a second end, the second end of the OLED receives a first predetermined voltage and is coupled to a second end of the driving transistor, and each of the pixels further comprises:
a first switch having a first end for receiving a data signal, a second end coupled to a first end of the driving transistor, and a control end for receiving a first control signal;
a capacitor having a first end and a second end coupled to a control end of the driving transistor;
a driving circuit for controlling electrical connection between the first end of the capacitor and the first end of the driving transistor according to a light emission control signal;
a compensation circuit for controlling electrical connection between the second end of the capacitor and the first end of the OLED according to a second control signal; and
a discharging circuit, coupled to the first end of the OLED and an initial voltage, controlling electrical connection between the first end of the OLED and the initial voltage according to a third control signal;
wherein the first shared circuit of the each pixel circuit couples the first end of the capacitor to a second predetermined voltage or the reference voltage according to the second control signal and the light emission control signal.

6. The display apparatus of claim 5, wherein the first shared circuit comprises:
a second switch having a first end for receiving the reference voltage, a second end coupled to the first end of the capacitor, and a control end for receiving the second control signal; and
a third switch having a first end for receiving the second predetermined voltage, a second end coupled to the first end of the capacitor, and a control end for receiving the light emission control signal.

7. The display apparatus of claim 6, wherein the each pixel circuit further comprises a second shared circuit, wherein the pixels are provided between the first shared circuit and the second shared circuit, the second shared circuit comprising:
a fourth switch having a first end for receiving the reference voltage, a second end coupled to the first end of the capacitor, and a control end for receiving the second control signal; and
a fifth switch having a first end for receiving the second predetermined voltage, a second end coupled to the first end of the capacitor, and a control end for receiving the light emission control signal.

8. The display apparatus of claim 1, wherein the OLED has a first end and a second end, the second end of the OLED receives a first predetermined voltage and is coupled to a second end of the driving transistor, and each of the pixels further comprises:
a first switch having a first end for receiving a data signal, a second end coupled to a first end of the driving transistor, and a control end for receiving a first control signal;
a capacitor having a first end coupled to the first shared circuit and a second end coupled to a control end of the driving transistor;
a driving circuit for controlling whether the first end of the capacitor and the first end of the driving transistor receive a second predetermined voltage according to a light emission control signal;
a compensation circuit for controlling electrical connection between the second end of the capacitor and the first end of the OLED according to a second control signal; and
a discharging circuit, coupled to the first end of the OLED and an initial voltage, controlling electrical connection between the first end of the OLED and the initial voltage according to a third control signal;
wherein the first shared circuit of the each pixel circuit couples the first end of the capacitor to the reference voltage according to the second control signal.

9. The display apparatus of claim 5, wherein the reference voltage is not greater than a sum of a first number and a second number, the first number is a difference between a maximum voltage of the data signal and an absolute value of the threshold voltage of the driving transistor, the second number is a difference between the second predetermined voltage and a gate cut-off voltage of the driving transistor, and the initial voltage is not greater than a difference between a minimum voltage of the data signal and the absolute value of the threshold voltage of the driving transistor, and the initial voltage is less than a sum of the first predetermined voltage and a threshold voltage of the OLED.

10. The display apparatus of claim 5, wherein:
during a first period of time, both the light emission control signal and the first control signal are at a first voltage, and both the second control signal and the third control signal are at a second voltage;
during a second period of time, both the light emission control signal and the voltage of the third control signal are at the first voltage, both the first control signal and the second control signal are at the second voltage, wherein the second period of time is after the first period of time; and
during a third period of time, the light emission control signal is at the second voltage, and the first control signal, the second control signal, and the third control signal are at the first voltage, wherein the third period of time is after the second period of time; and
during a fourth period of time, both the light emission control signal and the third control signal are at the second voltage, and both the first control signal and the second control signal are at the first voltage, wherein the fourth period of time is after the third period of time.

11. The display apparatus of claim 10, wherein the correction circuit adjusts a potential of the reference voltage received by each pixel circuit during the fourth period of time according to a sum of currents of discharging circuits of the pixels during the fourth period of time.

12. The display apparatus of claim 8, wherein the first shared circuit comprises:
a second switch having a first end for receiving the reference voltage, a second end coupled to the first end of the capacitor, and a control end for receiving the second control signal.

13. The display apparatus of claim 12, wherein the each pixel circuit further comprises a second shared circuit, wherein the pixels are provided between the first shared circuit and the second shared circuit, the second shared circuit comprising:
a fourth switch having a first, end for receiving the reference voltage, a second end coupled to the first end of the capacitor, and a control end for receiving the second control signal.

14. A display apparatus, comprising:
a display panel comprising a plurality of pixel circuits, each of the pixel circuits comprising:
a plurality of pixels, each of the pixels comprising:
an OLED;
a driving transistor for driving the OLED; and
a driving circuit for receiving a reference voltage and compensating a shift in a threshold voltage of the driving transistor; and
a first shared circuit, coupled to the pixels, for transmitting a second predetermined voltage to the pixels according to a light emission control signal; and
a correction circuit, coupled to the pixel circuits, for detecting a driving current of each pixel and adjusting the reference voltage received by the driving circuit of the each pixel according to the detected driving current of the each pixel.

15. The display apparatus of claim 14, wherein the OLED has a first end and a second end, the second end of the OLED receives a first predetermined voltage and is coupled to a second end of the driving transistor, and each of the pixels further comprises:
a first switch having a first end for receiving a data signal, a second end coupled to a first end of the driving transistor, and a control end for receiving a first control signal;
a capacitor having a first end coupled to the first shared circuit and a second end coupled to the control end of the driving transistor;
a compensation circuit for controlling electrical connection between the second end of the capacitor and the first end of the OLED according to a second control signal; and
a discharging circuit, coupled to the first end of the OLED and an initial voltage, controlling electrical connection between the first end of the OLED and the initial voltage according to a third control signal;
wherein the driving circuit controls electrical connection between the first end of the capacitor and the first end of the driving transistor according to the light emission control signal and controls whether the first end of the capacitor receives the reference voltage according to the second control signal; and
wherein the first shared circuit of each pixel circuit couples the first end of the capacitor to the second predetermined voltage according to the light emission control signal.

16. The display apparatus of claim 15, wherein the first shared circuit comprises:
a third switch having a first end for receiving the second predetermined voltage, a second end coupled to the first end of the capacitor, and a control end for receiving the light emission control signal.

17. The display apparatus of claim 16, wherein the each pixel circuit further comprises a second shared circuit, wherein the pixels are provided between the first shared circuit and the second shared circuit, the second shared circuit comprising:
a fifth switch having a first end for receiving the second predetermined voltage, a second end coupled to the first end of the capacitor, and a control end for receiving the light emission control signal.

18. A method for controlling the display apparatus of claim 14, comprising:
during a first period of time, setting both the light emission control signal and the first control signal to a first voltage, setting both the second control signal and the third control signal to a second voltage;
during a second period of time, setting both the light emission control signal and the third control signal to the first voltage, and setting both the first control signal and the second control signal to the second voltage, wherein the second period of time is after the first period of time; and
during a third period of time, setting the light emission control signal to the second voltage, setting the first control signal, the second control signal, and the third control signal to the first voltage, wherein the third period of time is after the second period of time; and
during a fourth period of time, setting both the light emission control signal and the third control signal to the second voltage, and setting both the first control signal and the second control signal to the first voltage, wherein the fourth period of time is after the third period of time.

19. The method of claim 18, further comprising:
adjusting potential of the reference voltage received by the each pixel circuit during the fourth period of time according to a sum of currents of discharging circuits of all the pixels of the each pixel, circuit during the fourth period of time.
